(19) United States
(12) Patent Application Publication
(10) Pub. No.: US 2007/0253445 A1
(43) Pub. Date: Nov. 1, 2007

(54) METHOD FOR THE BANDWIDTH DETECTION

(75) Inventor: Chih-Fang Lee, Hsinchu City (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Arcadyan Technology Corporation

(21) Appl. No.: 11/380,506

(22) Filed: Apr. 27, 2006

(51) Int. Cl. H04J 3/22

(52) U.S. Cl. 370/468; 370/252

(57) ABSTRACT

The present invention provides a method for detecting the bandwidth and other useful parameters of the network status. With these detected result, especially the upstream bandwidth and the downstream bandwidth, the setting of the on-line service or application, which is usually sensitive to the network status, could be appropriately determined. In other words, the type of Codec, the transfer rate and the RTP packet interval could be perfectly determined for adequately utilizing the network in order to improve the quality of the on-line service or application.

### FILED OF THE INVENTION

The present invention is related to a method for detecting the bandwidth, particularly to a method for detecting a bandwidth for VoIP or real-time media service.

### BACKGROUND OF THE INVENTION

With the prompt development of the network technology and the broadening of the Internet bandwidth, the on-line service spreads widely in our daily life. More and more convenient Internet applications are provided to the users. For example, one could make a phone call to a distant friend through Internet by means of the VoIP service, and probably no additional fee is required. Besides, the on-line TV service is also available additional to the Internet users. With such service, no TV program would be forgotten to watch. As computer technology advances, a great number of applications are performed through the network with digital (or discrete) signals as opposed to analog signals. Digital signals can be manipulated by computer systems for many advantageous applications.

However, the bandwidth of the network is limited by a certain maximum bandwidth, the more application are performed at the same time through the network, and the less bandwidth is shared by each application. Some types of signals, such as voice or video must have enough bandwidth for transmission.

Nevertheless, since the broadband Internet service is so popular nowadays, some users still has not to apply this service yet. In this way, the quality of the on-line service may therefore be influenced, and some modification or setting should be made by the service providers or the users.

Unfortunately, the user is usually unable to know the applied bandwidth, and the practical bandwidth is somewhat lower than the theoretical bandwidth. For the on-line voice or video application, the network bandwidth is especially significant to the quality. Besides, the determination of the Codec, transfer rate or RTP (real-time transport protocol) packet interval mainly relied on the value of bandwidth, so an appropriate approach for detecting the current bandwidth is certainly required.

### SUMMARY OF THE INVENTION

In view of the aforementioned problems, the present invention provides the method for detecting the network status including the network bandwidth, the round trip delay, network delay, the packet loss and the Jitter. With the instant information about the bandwidth, the type of Codec, (video) transfer rate as well as the RTP packet interval could be properly determined. In this way, the quality of the on-line service would be therefore highly raised.

According to one aspect of the present invention, a method for detecting a network status is provided. Initially, plural upstream packets are sent continuously from the client terminal to the server terminal, and each of the upstream packets has a substantially equivalent upstream packet size. After these upstream packets are received by the server terminal, an average upstream time interval of receiving time would be calculated. In the end, an upstream bandwidth is determined by dividing the upstream packet size by the calculated average upstream time interval, and network status mainly includes this upstream bandwidth.

According to another aspect of the present invention, a method for determining a transferring mode is provided. First, plural upstream packets are sent continuously from a client terminal to a server terminal, and as last upstream packet is received by the server terminal, plural downstream packets would be sent from the server terminal to the client terminal. Each of the upstream and downstream packets has a substantially equivalent downstream packet size. After the upstream packets are received by the server terminal, an average upstream time interval of receiving time is calculated, and then an upstream bandwidth would be determined by dividing the upstream packet size by the calculated average upstream time interval. Similarly, an average downstream time interval of receiving time of the downstream packets is calculated, and a downstream bandwidth would be determined by dividing the downstream packet size by the calculated average downstream time interval. Finally, the transferring mode is determined according to the upstream bandwidth and the downstream bandwidth.

According to still another aspect of the present invention, a method for detecting a bandwidth is provided. First, plural packets are sent continuously from the client terminal to the server terminal, and each of the packets has a substantially equivalent packet size. After these packets are received by the server terminal, an average time interval of receiving time would be calculated. Finally, the bandwidth is determined by dividing the packet size by the calculated average time interval.

### BRIEF DESCRIPTION OF THE DRAWINGS

FIG. 1 illustrates the flow chart according to the present invention.

FIG. 2 illustrates the diagram showing the relation between the packets and the time according to the present invention.

### DETAILED DESCRIPTION OF THE PREFERRED EMBODIMENT

The present invention is described with the preferred embodiments and accompanying drawings. It should be appreciated that all the embodiments are merely used for illustration. Although the present invention has been described in terms of a preferred embodiment, the invention is not limited to this embodiment. The scope of the invention is defined by the claims. Modifications within the spirit of the invention will be apparent to those skilled in the art.

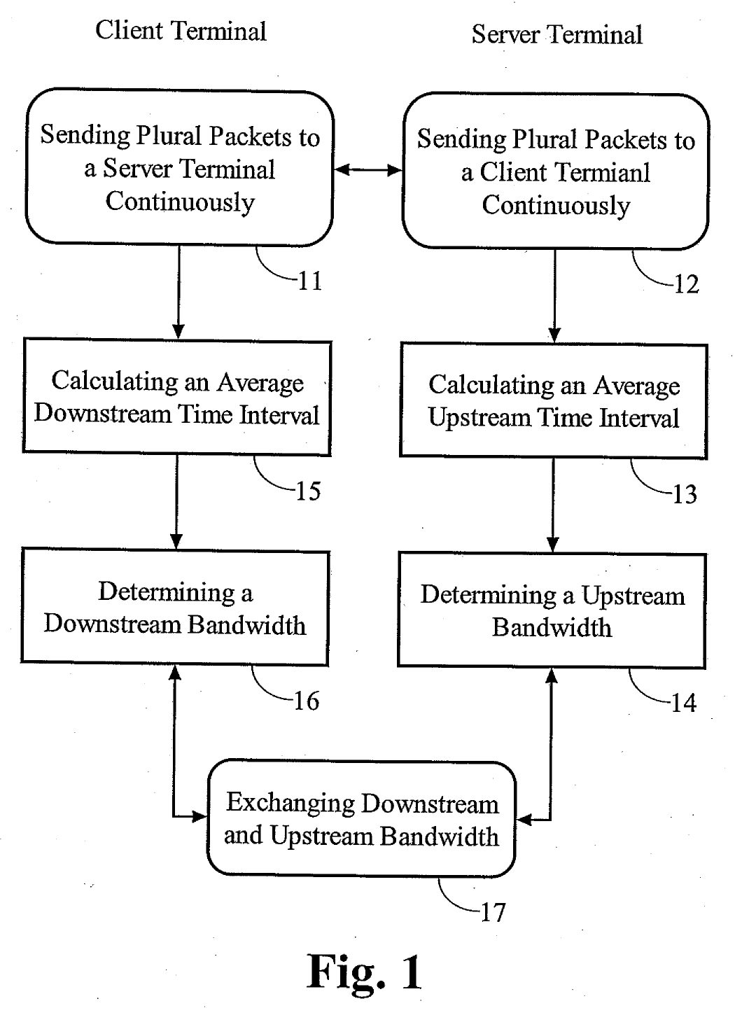

Please refer to FIG. 1, which illustrates a flow chart according to the preferred embodiment of the present invention. Initially, the client terminal would send plural packets to the server terminal continuously in step 11, and these packets are preferably named as the upstream packets for distinguishing other packets. Theoretically, the greater the number of the upstream packets is, the accuracy of the detected result would be. In this embodiment, there are five upstream packets would be sent, for instance. It should be noted that this number of the upstream packets is merely cited for illustration, instead of limitation. Besides, these upstream packets are UDP or RTP (real-time transferring protocol) packers which have a unique ID to identify that is a bandwidth detecting packet, also have timestamp which record the transmitting time and have substantially identical packet size in the embodiment.

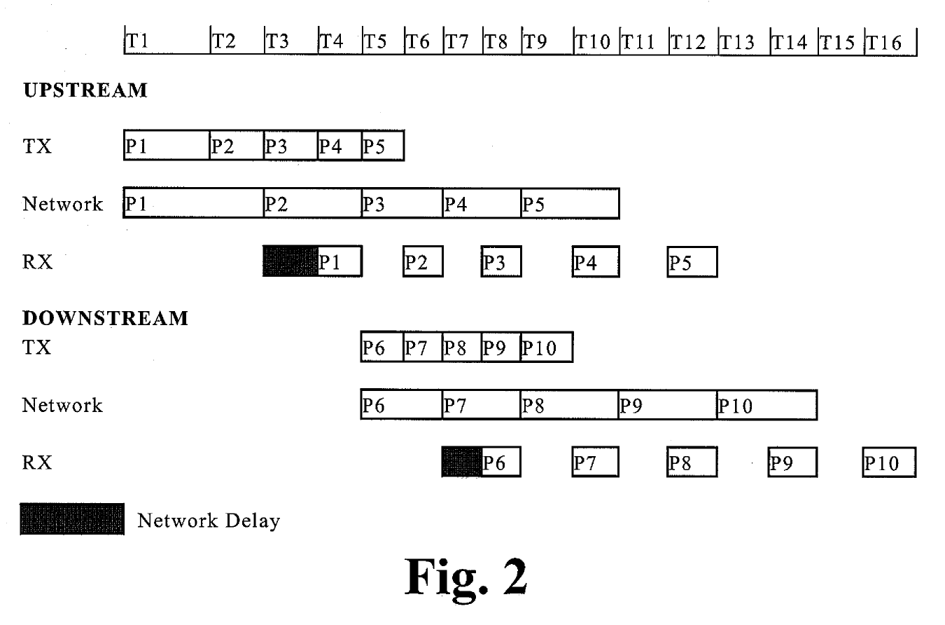

After the upstream packets are received by the server terminal, the average upstream time interval would be calculated in step 13. In this embodiment, the server terminal would also send plural downstream packets continuously to the client terminal as the first upstream packet is received, as shown in step 12. The downstream packets would be further illustrated in following description. Please also refer to FIG. 2, which is a block diagram showing the relation between the packets and the time. In the UPSTREAM portion, the TX column presents that five upstream packets P1-P5 are sent by the client terminal. Then the packets P1-P5 would be transferred by the network, and finally received by the server terminal, as shown in Network column and RX column. As we can see, the transferring rate is mainly controlled by the network and is limited by the application on the network, and the upstream bandwidth of such network would be detected in the preferred embodiment. After the bandwidth is detected, the user can select the proper Codec, proper Video transfer rate or RTP packet interval according to the detected network bandwidth. Typically, pluralities of Codec versions are incorporated into the computer system. Thus, based on the detected bandwidth, the computer may select proper Codec to fit the current bandwidth.

The upstream packets will be consequently received by the server terminal, and the receiving time of each upstream packet is recorded. For example, P1 is received at T5, P2 is received at T7, P3 is received at T9, P4 is received at T11 and P5 is received at T13. The average upstream time interval AUTI could be calculated by formula 1.

$$AUTI = \frac{T 13 - T 5}{4} \qquad Formula 1$$

If only two upstream packets P1 and P2 are adopted or sent, the average upstream time interval could be T7-T5. Nevertheless, the more packets are sent, the higher accuracy is achieved.

Please refer to FIG. 1, in step 14, after the upstream time interval is obtained, the upstream bandwidth would be determined accordingly. In the preferred embodiment, the packet size of the upstream packet is divided by the calculated average upstream time interval AUTI for determining the upstream bandwidth, as shown in formula 2. It is noted that the packet sizes of all upstream packets are substantially the same in this embodiment, as mentioned above. Since the network delay of the receiving time of every upstream packet is similar, the influence of the network delay could be ignored in the embodiment.

$$Upstream Bandwidth = \frac{Packet Size}{Average Upstream Time Interval ( AUTI )} \qquad Formula 2$$

Besides the upstream bandwidth, other parameters of the network status, such as the downstream bandwidth or the packet loss, are also demanded in certain on-line application for determining the superior transferring mode. With such transferring mode, the performance of the on-line application could therefore be highly promoted. To obtain other useful parameters, plural downstream packets are sent continuously from the server terminal to the client terminal as the first upstream packet P1 is received, namely at the time T5, as shown in step 12. Similar with the situation of upstream packets, in the DOWNSTREAM portion, the TX column presents that five downstream packets P6-P10 are sent by the server terminal. Then the packets P6-P10 would be transferred by the network, and finally received by the client terminal, as shown in Network column and RX column. After that, the average downstream time interval would be calculated in step 15, and then the downstream bandwidth is determined accordingly in step 16. Since the calculation of the average downstream time interval as well as the determination of downstream bandwidth is almost the same with the situation of upstream bandwidth, the related description is omitted herein for preventing unnecessary redundant.

Finally, after the upstream bandwidth and downstream bandwidth are respectively obtained, the bandwidth information would be exchanged between the client terminal and server terminal, as shown in step 17. In this way, both terminals could maintained complete bandwidth information for further applications.

Since this bandwidth calculation need to involve both client and server site, if only one site could be controlled, there have the other way to calculate the network bandwidth. At this situation, the network bandwidth would be calculated by transmitting completed timestamp between two packets to calculate, rather than applying the received packet interval. The formula is similar with those mentioned above, except changing the received packet timestamp to transmitting completed timestamp.

In the preferred embodiment, the packet sizes of the downstream packets are substantially identical and preferably the same as those of the upstream packets. Besides, the number of the downstream packets is preferably the same as that of the upstream packets.

In addition to the upstream bandwidth and the downstream bandwidth, other useful parameter could be calculated in the aforementioned process. For example, the round trip delay could be obtained by calculating a difference between the transmitting time of the first upstream packet and the receiving time of first downstream packet. Besides, the network delay is a half of the value of the round trip delay. The packet loss rate could be calculated by dividing the number of the sent packets in one terminal by the number of the actually received packets in another terminal. Moreover, Jitter could be calculated by formula 3 or formula 4.
Jitter=T(Pi)+AUTI−T(Pi+1), i=1 to 5 formula 3
Jitter=T(Pi)+ADTI−T(Pi+1), i=6 to 10 formula 4

In formula 3, T(Pi) is the receiving time of upstream packet Pi, AUTI represents average upstream time interval. Similarly, in formula 4, T(Pi) is the receiving time of downstream packet Pi, ADTI represents average downstream time interval.

With the obtained parameters of the network status, especially the upstream bandwidth and the downstream bandwidth, the transferring mode including the proper codec, transfer rate or RTP packet interval could be chosen or determined accordingly. Consequentially, the quality of the on-line service or application could be highly improved by utilizing the network perfectly.

As is understood by a person skilled in the art, the foregoing preferred embodiments of the present invention are illustrated of the present invention rather than limiting of the present invention. It is intended to cover various modifications and similar arrangements included within the spirit and scope of the appended claims, and the scope of which should be accorded the broadest interpretation so as to encompass all such modifications and similar structure. While preferred embodiment of the invention has been illustrated and described, it will be appreciated that various changes can be made therein without departing from the spirit and scope of the invention.

Having described the invention, the following is claimed:

1. A method for detecting a bandwidth, comprises;
sending plural upstream packets continuously, wherein each of said upstream packets has a substantially equivalent upstream packet size;
calculating an average upstream time interval of receiving time of said plural upstream packets; and
determining an upstream bandwidth by dividing said upstream packet size by said average upstream time interval.

2. The method as set forth in claim 1, wherein said upstream time interval is calculated by steps comprising:
recording receiving time of each upstream packets when each of said plural upstream packets is received;
subtracting receiving time of first one of said plural upstream packets from receiving time of last one of said plural upstream packets to obtain an upstream time interval;
dividing said upstream time interval by number of said plural upstream packets to obtain said average upstream time interval.

3. The method as set forth in claim 1, wherein at least two said upstream packets are sent.

4. The method as set forth in claim 1, wherein said plural upstream packets are UDP packets.

5. The method as set forth in claim 1, wherein said network status includes said upstream bandwidth and a codec or a transfer rate is determined accordingly.

6. The method as set forth in claim 1, wherein said plural upstream packets are sent from a client terminal to a server terminal.

7. The method as set forth in claim 6, which further comprises:
sending plural downstream packets from said server terminal to said client terminal as first one of said upstream packets is received by said server terminal, wherein each of said downstream packets has a substantially equivalent downstream packet size;
calculating an average downstream time interval of receiving time of said plural downstream packets; and
determining a downstream bandwidth by dividing said downstream packet size by said average downstream time interval.

8. The method as set forth in claim 7, wherein said upstream packet size is substantially the same as said downstream packet size and number of said upstream packets is identical to number of downstream packets.

9. The method as set forth in claim 7, wherein said network status includes said downstream bandwidth and a codec or a transfer rate is determined accordingly.

10. The method as set forth in claim 7, wherein said network status includes a round trip delay, wherein said round trip delay is obtained by calculating a difference between receiving time of said last one of said upstream packet and receiving time of first one of said downstream packet.

11. The method as set forth in claim 8, wherein said network status includes a network delay, wherein said network delay is a half of said round trip delay.

12. The method as set forth in claim 7, wherein said network status includes the packet loss or Jitter.

13. The method as set forth in claim 7, which further comprises:
exchanging information of said upstream bandwidth and said downstream bandwidth between said client terminal and server terminal.

14. A method for detecting a bandwidth, comprises:
sending plural upstream packets continuously from a client terminal to a server terminal;
sending plural downstream packets from said server terminal to said client terminal as first one of said upstream packets is received by said server terminal, wherein each of said upstream packets and said downstream packets has a substantially equivalent downstream packet size
calculating an average upstream time interval of receiving time of said plural upstream packets;
determining an upstream bandwidth by dividing said upstream packet size by said average upstream time interval;
calculating an average downstream time interval of receiving time of said plural downstream packets;
determining a downstream bandwidth by dividing said downstream packet size by said average downstream time interval; and
determining a transferring mode according to said upstream bandwidth and said downstream bandwidth.

15. The method as set forth in claim 14, wherein said upstream or downstream time interval is calculated by steps comprising:
recording when each of said plural upstream or downstream packets is received;
subtracting receiving time of first one of said plural upstream or downstream packets from receiving time of last one of said plural upstream or downstream packets to obtain an upstream or downstream time interval; and
dividing said upstream or downstream time interval by number of said plural upstream or downstream packets to obtain said average upstream or downstream time interval.

16. The method as set forth in claim 14, wherein number of said upstream packets is identical to number of downstream packets and at least two.

17. The method as set forth in claim 14, wherein said plural upstream packets are UDP packets.

18. The method as set forth in claim 14 wherein said transferring mode includes a codec or a transfer rate.

19. The method as set forth in claim 14, which further comprises:
exchanging information of said upstream bandwidth and said downstream bandwidth between said client terminal and server terminal

20. A method for detecting a bandwidth, comprises:
sending plural packets continuously, wherein each of said packets has a substantially equivalent packet size;
calculating an average time interval of receiving time of said plural packets; and
determining said bandwidth by dividing said packet size by said average time interval.

21. The method as set forth in claim 20, wherein a number of said plural packets is at least two.

22. The method as set forth in claim 20, wherein said plural packets are UDP packets.

23. The method as set forth in claim 20, wherein a codec or a transfer rate is determined according to said bandwidth.
